(19) United States
(12) Patent Application Publication
(10) Pub. No.: US 2010/0321235 A1
(43) Pub. Date: Dec. 23, 2010

(54) Imaging Method Utilizing a Synthetic Aperture, Method for Determining a Relative Velocity Between a Wave-Based Sensor and an Object, or Apparatus for Carrying Out the Methods

(75) Inventors: Martin Vossiek, Hildesheim (DE); Stephan Max, Neubokel/Gifhorn (DE); Peter Gulden, Munich (DE)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: SYMEO GMBH, Neubiberg (DE)

(21) Appl. No.: 12/821,780

(22) Filed: Jun. 23, 2010

(30) Foreign Application Priority Data
Jun. 23, 2009 (DE) 10 2009 030 076.7

(51) Int. Cl. G01S 13/90

(52) U.S. Cl. 342/25 A

(57) ABSTRACT

An imaging method is provided for imaging or locating an object with a wave-based sensor. A wave field emanates from the object as an object signal, with this object signal emanating from a sensor is received at a sensor position, and wherein the sensor(s) and the object assume a number of spatial positions with respect to each other and form a synthetic aperture, and an echo signal is sensed at each of these sensor positions, a number of function values is extracted from the echo signals, which are allocated to a space coordinate of the object, and a signal with a residual phase characteristic is formed from the function values. Based on a residual phase characteristic that is due to a deviation of real sensor positions from assumed or measured sensor positions, an image point, the object position or the relative movement of the object is determined.

### CROSS-REFERENCE TO RELATED PATENT APPLICATION

This application claims the benefit of German Patent Application No. 10 2009 030 076.7, filed on Jun. 23, 2009, in the German Patent Office, the disclosure of which is incorporated herein in its entirety by reference.

### BACKGROUND

Various embodiments of the invention relate to an imaging method with a synthetic aperture and for imaging or locating an object with a wave-based sensor by way of a synthetic aperture, to a method based thereon for determining a relative velocity between a wave-based sensor and an object, or to an apparatus for carrying out the method.

Methods on the basis of the so-called synthetic aperture (SA) by way of radar technology, in particular, are used to create an image of an object, for example, an image of the earth surface. A general principle of SA systems is exhaustively explained for a wave range of microwaves, for example, in the text book entitled “H. Radar with Real and Synthetic Aperture” by Clausing and W. Holpp, Oldenbourg, 2000, chapter 8, page 213 and the following, or in M. Younis, C. Fischer and W. Wiesbeck, “Digital beamforming in SAR systems”, Geoscience and Remote Sensing, IEEE Transactions on, vol. 41, pp. 1735-1739, 2003. SA methods are also known, for example, from International Patent Application No. WO 2006/072471, German Patent Document No. DE 199 10 715 C2 or European Patent Document No. EP 0 550 073 B1. In the field of radar sensories, this context is also referred to as SAR (Synthetic Aperture Radar) or even SDRS (Software-Defined Radar Sensors).

Almost identical methods have long been known in the field of medicine or ultrasonic measuring technology, referred to as holography, or tomography, and have been described, for example, in M. Vossiek, V. Mágori, and H. Ermert, “An Ultrasonic Multielement Sensor System for Position Invariant Object Identification”, presented at IEEE International Ultrasonics Symposium, Cannes, France, 1994, or M. Vossiek, “An Ultrasonic Multi-transducer System for Position-independent Object Detection for Industrial Automation”, Fortschritt-Berichte VDI, Reihe 8: Mess-, Steuerungs- and Regelungstechnik, vol. 564, 1996.

It is generally known, that SA methods can be carried out with all coherent waveforms, for example with electromagnetic waves in the field of radar, and with acoustic waves in the medical field of ultrasonic waves. Signals of wave sources, the characteristic and coherence of which the receiver does not know, can also be processed with SA methods, if a signal is formed of signals received from at least two spatially separated locations, which no longer describes the absolute phase, but phase differences of the signals, is known, for example, from German Patent Document No. DE 195 12 787 A1.

A great variety of secondary radar methods is also known, as they are described, for example, in German Patent Document Nos. DE 101 57 931 C2, DE 10 2006 005 281, DE 10 2005 037 583, Stelzer, A., Fischer, A., Vossiek, M.: “A New Technology for Precise Position Measurement-LPM”, Microwave Symposium Digest, 2004, IEEE MTT-S International, vol. 2, 6-11 Jun. 2004, pp. 655-658, or in R. Gierlich, J. Huttner, A. Ziroff, and M. Huemer, “Indoor positioning utilizing fractional-N PLL synthesizer and multi-channel base stations”, Wireless Technology, 2008, EuWiT 2008, European Conference on, 2008, pp. 49-52, or in S. Roehr, P. Gulden, and M. Vossiek, “Precise Distance and Velocity Measurement for Real Time Locating in Multipath Environments Using a Frequency-Modulated Continuous-Wave Secondary Radar Approach”, IEEE Transactions on Microwave Theory and Techniques, vol. 56, pp. 2329-2339, 2008.

Transformations used in the technical implementation are also known. Suitable wavelet or time-frequency transformations are supplied, for example, by Shie Qian, “Introduction to Time-Frequency and Wavelet Transforms”, Prentice Hall 2001. Spectral evaluation methods, such as FFT (Fast Fourier Transformation) and time-domain based methods have been described, for example, in S. L. Marple, Jr., “A tutorial overview of modern spectral estimation”, Acoustics, Speech, and Signal Processing, 1989, ICASSP-89, 1989 International Conference on, 1989, pp. 2152-2157 vol. 4.

For the understanding of the SA methods in the following explanations, in particular, the so-called broadband holographic imaging method will be of importance. An explanation of a sensing situation of an image by way of the broadband holographic imaging method is given with reference to FIG. 5.

An object O is shown fixed in a Cartesian coordinate system x, y, z. A space coordinate r of object O, or an image point of its surface is to be determined within the coordinate system x, y, z. A point of the surface of the object O, in particular a scatter point P or a transponder, radiates as an object signal os as a passive or active transmitter. An object position P(r)=P_{O1}=(x_{O1}, y_{O1}, z_{O1})^{T} of the object O, or of its transponder or scatter point P, is thus to be determined.

For this purpose, a sensor SS is moved along a sensor path sw, or a sensor movement trajectory. The sensor comprises an antenna A and a receiver RX, which senses the object signal os, which reaches the antenna A from the scatter point P or transponder, both via a direct path rₙ and, at a later time, arriving in a time-shifted manner, via echoes or diversions. The signal received by the antenna A at a time t is processed by a processor C and output as a received signal that is also referred to as an echo profile or echo signal eₙ(t). It is generally known that values can be converted by way of a time axis with time t as a variable of the echo signal eₙ(t) by way of its propagation velocity into values of a distance axis, i.e., with position coordinates as variables.

Herein, sensing is carried out in a time sequence at various apparent sensor positions aₙ=(xₙ, yₙ, zₙ)^{T}, wherein n is an element of the number 1, 2, . . . n, . . . M of the sensor positions aₙ, so that a spatial image of the object O can be generated by way of the synthetic aperture.

Herein, it is generally known that the sensor SS also includes a transmitter TX, which transmits a transmitting signal sₙ(t) in particular in the direction toward the object O. The transmitting signal sₙ(t) arriving at the object O via direct or indirect paths is then emitted by the object O as the object signal os.

The data sensing is thus carried out in such a manner that at least one radar device emits a signal from the apparent sensor position aₙ=(xₙ, yₙ, zₙ)^{T} in the direction toward an object scene. This radar signal is then to be scattered and/or reflected at a point scatterer of the object O at the object position P(r)=P_{O1}=(x_{O1}, y_{O1}, z_{O1})^{T}. For reasons of clarity, it is initially assumed that the radar device initially receives the object signal os reflected back from the object O at the same apparent sensor position aₙ. A transfer to an arrangement with separate transmitting and receiving antennas is easily possible, for example with the aid of the above-mentioned literature. Such a measuring process is carried out from M different apparent measuring or sensor positions aₙ, wherein n=1 . . . M. Consequently, the measurement results in a group of M different measuring or echo signals eₙ(t), or in the associated echo spectra Eₙ(ω).

The true position, ideally to be determined by the measurement, of the transponder, or the scatter point, is thus the object position P(r)=P_{O1}=(x_{O1}, y_{O1}, z_{O1})^{T}.

To achieve a compact explanation, further simplifications will be assumed in the following. A measuring range, within which the object O can be present is limited to a spatial range in which it is ensured that the object O can be detected by the radar device or the sensor SS from all apparent sensor positions aₙ. Also, a uniform, constant and non-direction-dependent directional behavior of all antennas will be assumed in the following.

The basis for modeling a transmission channel formed by the measuring paths rₙ is assumed to be an ideal AWGN channel (AWGN: Additive White Gaussian Noise). I.e., the echo signal eₙ(t) received by the sensor SS can be described with a model in which the echo signal eₙ(t) results as a linear superposition of a plurality P of amplitude-weighted and time-delayed transmitting or object signals os, wherein an index P indicates the different transmission paths, i.e., the direct path and so-called multipath diversions, from the radar device or sensor SS to the object O and back. Then, for the echo signal eₙ(t)

$${e}_{n} ( t ) = {α}_{n} \cdot {\sum }_{p = 1}^{P} {α}_{p} \cdot s ( t - {τ}_{n} - {τ}_{p} ) + N ( t )$$

wherein αₙ is a direct path attenuation characteristic for the direct measuring path rₙ, in particular a direct path attenuation constant, wherein αₚ additionally takes the attenuation for each of the p transmission paths, beyond the normal direct path attenuation αₙ, into consideration.

It is also assumed that τₙ is a characteristic direct path signal delay for the direct measuring path rₙ, i.e., the signal delay of the direct, shortest path from the radar device or transmitter TX to the object O and back. Moreover, τₚ is for taking possible delay extensions due to multiple reflections into account for each of the transmission paths. For the index P=1, i.e., for the direct measuring path rₙ, the delay extension is τₚ=0.

Moreover, n(t) describes additively superimposed interference in the form of AWGN.

If this equation for the transmission model is transformed into the frequency domain, the result is the echo spectrum

$${E}_{n} ( ω ) = {α}_{n} \cdot {\sum }_{p = 1}^{P} {α}_{p} \cdot S ( ω ) \cdot {e}^{- j \cdot ω \cdot {τ}_{n}} \cdot {e}^{- j \cdot ω \cdot {τ}_{p}} + N ( ω )$$

wherein S(ω) is the transmitting spectrum of the transmission signal s(t), and N(ω) is the noise spectrum of the AWGN. The direct path signal delay τₙ to any space coordinate r=(x, y, z)^{T} and back is calculated according to

$${τ}_{n} = \frac{2 \cdot \vert {r}_{n} \vert}{c} and$$

$$\vert {r}_{n} \vert = \vert r - {a}_{n} \vert = \sqrt{{( x - {x}_{n} )}^{2} + {( y - {y}_{n} )}^{2} + {( z - {z}_{n} )}^{2}}$$

wherein c is a propagation velocity of the wave.

A so-called “broadband holographic reconstruction algorithm” is based on a technique of optimum filtering. For calculating an image point b(x,y,z) at object O, the measured receiving or echo spectrum Eₙ(ω) is correlated with a theoretical ideal function Fₙ(aₙ, r, ω), wherein the ideal function Fₙ(aₙ, r, ω) would create a scatter point P, or a point scatterer, that is at any point in the object scene, at the space coordinate r=(x,y,z)^{T}, as seen from the apparently measured sensor position aₙ=(xₙ, yₙ, zₙ)^{T}. This correlation or comparative function, results in a value that is the greater the more the receiving signal or echo signal eₙ(t) is similar to the theoretical signal.

A great similarity of the signals is present if a point scatterer is actually present at the position of the space coordinate r, i.e., the assumed image point b(r) actually corresponds to the real reflector position P_{TP1}=(x_{TP1}, y_{TP1}, z_{TP1})^{T} of the reflector assumed as the scatter point P at the object O.

By summing the correlation results for all M direct measuring paths r₁, . . . rₙ, . . . r_{M}, a type of probability value results that indicates whether or not a point scatterer, i.e., a reflecting and/or scattering object structure, is present at the position of the space coordinate r. The reconstruction prescription is therefore:

$$b ( x , y , z ) = \vert {\sum }_{n = 1}^{M} {\int }_{ω} {E}_{n} ( ω ) \cdot {F}_{n}^{- 1} ( {a}_{n} , r = {( x , y , z )}^{T} , ω ) d ω \vert .$$

The inverse filter of the ideal function Fₙ⁻¹ chosen here in the manner of a correlation for signal comparison, corresponds to a so-called matched filter approach with respect to the exponential propagation term, i.e., corresponds to a multiplication with the conjugate complex signal, i.e., with Fₙ*(aₙ, r, ω).

Based on the above described transfer model and without taking the additive interferences n(t) into account and without taking multiple reflections into account, the result is a signal of a fictitious point scatterer at the space coordinate r in the ideal function Fₙ(aₙ, r, ω)=αₙ·S(ω)·e^{-j·ω·τ}^{ₙ}

Furthermore, it is assumed that the transmission signal is S(ω)=1, which is possible without limiting general applicability since any non-ideal properties of the transmission signal can be compensated in the spectral transmission range of the sensor system by the above explained approach of the inverse ideal filter in a manner known as such.

If this signal hypothesis is now substituted in the above introduced reconstruction prescription, it follows

$$b ( x , y , z ) = \vert {\sum }_{n = 1}^{M} \frac{1}{{α}_{n}} {\int }_{ω} {E}_{n} ( ω ) \cdot {e}^{j \cdot ω \cdot {τ}_{n}} d ω \vert .$$

It can be seen that the integral across the so-called circular frequency w corresponds to an inverse Fourier transformation and thus provides the receiving signal, or the echo signal eₙ(t) at time t=τₙ. The ultimate general reconstruction prescription, known as such, is thus

$$b ( x , y , z ) = \vert {\sum }_{n = 1}^{M} {e}_{n} ( t = {τ}_{n} ) \vert$$

and is referred to as a broadband holographic reconstruction formula.

It must be remarked that any real receiving signals are extended to form a complex signal prior to summing, so as to be able to determine an envelope of the imaging function, i.e., a type of “brightness function”. The calculation of the complex signal can preferably be carried out with the aid of the so-called Hilbert transformation.

The resulting term can be interpreted in a very illustrative manner. If there is actually a scattering body at the position of the space coordinate r, its response signal occurs in the echo signal eₙ(t) at each time t=τₙ. By summing in a manner correct with respect to the delays, across the M measuring paths, its signal contributions are coherently overlapped by the reconstruction prescription so that a large value results for b(x,y,z). Any signal components of other scattering bodies not positioned in the space coordinate r, signal components of multipath reflections or noise, however, incoherently overlap due to the non-consistent delays and thus result in a substantially weaker image signal. To ensure that an incoherent superposition of several echo signals e₁(t)+ . . . +eₙ(t)+ . . . +e_{M}(t) results in a substantially smaller amplitude than a coherent overlap, it is required that the number M of measuring points is at least 2 or larger, preferably substantially larger than 2.

It is generally known that the M measuring or sensor points aₙ=(xₙ, yₙ, zₙ)^{T} can be generated by several radar devices and/or by moving at least one radar sensor along the sensor path sw.

As in the approach shown, all SA methods known as such are based on superimposing signals of several M measurements based on a transmission and sensing or movement model in a phase-dependent manner.

For SA imaging to be able to function it is absolutely necessary according to the known SA methods and also in the illustrated broadband holographic methods, that the coordinates of the sensor positions aₙ=(zₙ, yₙ, zₙ)^{T} correspond with reality in a very precise manner since otherwise a correct delay and phase-corresponding coherent superposition is no longer possible. A typical requirement is that the deviation of all assumed sensor positions aₙ from the actual sensor positions aₙ_{_{—}}ᵣₑₐₗ must be much smaller than the wavelength of the echo signals eₙ(t) used.

A very attractive variant, known as such, for the implementation of an SA sensor SS is to mount one or more, if necessary, wave-based sensors SS on a vehicle, e.g., on an automobile, truck, aircraft, rail vehicle, fork-lift truck, robot, lifting frame, hoist, transport system or autonomous vehicle and to utilize the already present movement of the vehicle to define a synthetic aperture and to carry out the plurality of M spatially distributed measurements. However, to know the coordinates of the apparently instantaneous sensor positions aₙ=(xₙ, yₙ, zₙ)^{T} at each measuring time to a sufficient precision, it is necessary that the path of the vehicle as the sensor path sw is precisely measured. Such a precise measurement to a fraction of the wavelength of the transmission signals s(t) used, entails considerable overhead, however, or is frequently not possible at all. A reason can be, for example, a slip frequently occurring as a fork-lift truck is driven, or lateral rolling of wheels. Another exemplary reason could be integration errors often occurring in the use of acceleration or velocity sensors, since, in these sensors, the path traversed must be determined by way of a single or two-fold integration or, in Doppler sensors is due to an unknown and/or varying inclination angle of the sensor.

In addition to these measuring errors in the determination of the radar's own position, there is an additional problem in the case in which the M measurements are sequentially carried out as moving objects are imaged. As can be seen from the above explanations, the sensor position aₙ=(xₙ, yₙ, zₙ)^{T} of the sensor SS refers to a point scatterer of the object O at a fixed position P (r)=P_{O1}=(x_{O1}, y_{O1}, z_{O1})^{T}. However, if the object O moves during the M measurements, this additional relative movement should also be taken into consideration in the image reconstruction, or in the measured apparent sensor positions aₙ=(xₙ, yₙ, zₙ)^{T}.

A general measuring situation in a natural environment often involves the wave-based sensor SS detecting many objects O, some with different velocities. If a fork-lift truck or an autonomous vehicle or a robot on which a sensor SS is present, drives, for example, through a factory building, it can detect, in addition to the stationary plants, fixtures and building parts, also walking people or other moving vehicles.

It is not possible, however, with the well-known SA methods, to image all these objects with different relative velocity to the sensor SS with the same quality.

### SUMMARY

It is the object of various embodiments of the invention to solve this considerable technical problem by way of the practical application of SA methods. As a derivative of this solution, preferably, a method should also result, as to how a vehicle equipped with a wave-based sensor can determine its relative velocity or its relative path change with respect to other objects with the aid of such SA methods.

This object is achieved by the imaging method by way of a synthetic aperture between a wave-based sensor and an object described below, by the method based thereon for determining a relative velocity between the wave-based sensor and the object, or by an associated apparatus, described in more detail below.

What is provided is thus an imaging method with a synthetic aperture that is based on an evaluation of residual phase deviations, and based thereon, a method for determining a relative velocity between a wave-based sensor and an object, or an apparatus for carrying out the methods. Advantageous embodiments are the subject matter of dependent claims.

In particular, an imaging method for imaging or locating an object with a wave-based sensor by way of a synthetic aperture is preferred, wherein, from at least one object position, a wave field emanates from the object as an object signal, wherein the object signal is produced by either irradiating the object with at least one wave source and, in response, the object reflecting or scattering said wave field, or by the object independently emitting a wave form, and said object signal emanating from the object is received by the at least one sensor at at least one sensor position, and the sensor, or the sensors, and the object assume a number of at least two spatial positions relative to each other and thus form the synthetic aperture, and an echo signal is sensed by the sensor at each of said sensor positions, a number greater than 1 of several of the echo signals is formed of the echo signals, wherein the amplitude and/or the phase characteristic is a function of a signal delay or a signal delay difference or a function of a distance or a distance difference between the object and at least one of the sensors, and, of this number greater than 1 of the echo signals, at least one function value is extracted per each echo signal, wherein the extracted function values are allocated to an assumed space coordinate of the object. Such a method is advantageous in that the number of the extracted function values of the echo signals at their assumed sensor positions has a determinable, deterministic and non-constant residual phase characteristic that is due to a deviation of real sensor positions from assumed or measured sensor positions and/or is due to a movement of the object, and in that said residual phase characteristic is analyzed or compensated, and from the result of the analysis or the compensation, at least one image point of the object or the object position of the object or the relative movement of the object is determined or estimated.

The object position can be the position of the object as a whole, but can also be understood to be only a position of a point, in particular a reflection or scattering point, or a transponder antenna on the object.

The terms sensor and receiver can be used in a synonymous sense in so far as a sensor is understood to be one or more elements that has at least components of a receiver and is in a fixed relationship with additional components, if any, of a receiver.

The sensor moves, as the case may be, along a sensor path, in particular an unknown sensor path. Deterministic is to be understood as a physically fixed relationship that is commonly applicable to the phase characteristic of the largest portion of echo signals of interest at any one time, and is describable by way of a closed formula, in particular.

An echo signal can also comprise wave or signal portions that only traverse the direct path.

An analysis is, in particular, the application of a Fourier transformation or frequency estimation or a time-frequency analysis. A compensation is, in particular, a differentiation of the residual phase characteristic.

Such a method is preferred, wherein the determinism of the residual phase characteristic is in that it linearly varies over time or the index, or in that the extracted function values describe a sinusoidal function and in that an amplitude and/or a frequency and/or the phase of the sinusoidal function is determined by way of the frequency analysis method. The surprising idea utilized here is that a linear phase of the echo spectra, which, mathematically speaking, is equivalent to a sinusoidal characteristic of the fundamental function values, can be evaluated by way of a frequency analysis method in a simple manner.

Preferably a probability value is determined from the amplitude of the sinusoidal function, which indicates whether or not a wave field emanates from the space coordinate of the object.

Then the relative movement between the object and the at least one sensor can be determined from the frequency of the sinusoidal function.

In particular, such a method is preferred, wherein a phase difference of at least two of the extracted function values is formed, and this phase difference is used to determine the relative movement between the object and the at least one sensor.

A Fourier transformation can be applied in the context of the analysis of the extracted function values or of their phase characteristics, which enables simple calculation.

Herein, for reconstructing or for estimating the image points and/or the spatial drift velocity of an offset between the object and the at least one sensor, the Fourier transformation can be applied to at least a part of measuring values of at least two different ones of the echo signals, and a maximum thereof can be determined, and this is done, in particular, according to

b(x,y,z)=max {|FFT {eₙ(t=τₙ)}|}.

This is particularly advantageous in the case where a drift acceleration and a drift jerk, and in particular all higher non-linear drift components are equal to zero, that is if there is only one linear drift component, namely the velocity. In spite of a drift, a sharp image of the object can thus be determined.

Such a method is preferred wherein the residual phase characteristic of the number of extracted function values is differentiated and new function values are formed of the extracted function values, and such image points or an image or the object position or the relative movement of the object is determined from the newly formed function values. Herein, the differentiation of the residual phase characteristic can be repeated until a linear or constant phase characteristic establishes itself in the newly formed function values.

A plurality of such approaches is advantageous, wherein the determinism of the phase characteristic is that the phase characteristic of the echo signals has a phase, wherein the phase varies in correspondence to a square or cubic function characteristic over time, or wherein the extracted function values describe a linear or square frequency modulated function, and, with a mathematic analysis method, at least one parameter characterizing the function characteristic is determined, e.g., a coefficient of a polynomial describing the phase characteristic, e.g., the coefficient of the linear or square or cubic portions of this polynomial.

The measurements at the sensor positions are preferably carried out at constant time intervals during a scanning time.

A real sensor position can be determined from a sum of an apparently measured sensor position and an offset B(n), wherein the offset B(n) is described as a function of an apparently measured nth sensor position by the parameter characterizing the function characteristic, in particular according to

$$B ( n ) = {x}_{0} + {v}_{0} \cdot n + \frac{1}{2} {a}_{0} \cdot {n}^{2} + \frac{1}{3} {r}_{0} \cdot {n}^{3} + …$$

wherein x₀ is an offset for the first aperture point, or the first sensor position, v₀ is a drift velocity, a₀ is a drift acceleration, and r₀ is a drift jerk.

The analyzed echo signals can be sensed by both at least two different apparently measured sensor positions and at least two different object positions.

Such a method is suitable, in particular, for determining a relative velocity between the sensor and the object as the relative movement or a movement component thereof.

Independently, in particular, an apparatus is preferred with a wave-based sensor for sensing a sequence of echo signals of an object and with a logic and/or with a processor accessing at least one program, wherein the logic and/or the processor are configured for carrying out such a method. Typical for such an arrangement with SA methods, is a memory in which the values of the number greater than 1 of several of the echo signals are stored.

In particular, such an apparatus is equipped with a memory or an interface to a memory, wherein the program is stored in the memory. In a manner known as such, such an arrangement can include hardware components as the logic, adapted for running any required programs by way of suitable wiring or an integrated structure. The use of a processor including a processor of a computer connected via an interface, for example, can also be implemented to run a suitable program that is stored in an accessible manner. Combined approaches of fixed hardware and a processor are also possible.

### DESCRIPTION OF THE DRAWINGS

An exemplary embodiment will be described in the following with reference to the drawing in more detail, wherein, with respect to the aspects described with reference to the prior art the above explanations are pointed out. In particular:

FIG. 1 shows a measuring situation with an object moving in space and a sensor path, along which measuring or sensor points of one or more wave-based sensors are arranged in a distributed manner,

FIG. 2 schematically shows components required for determination in the case of an object moving in the reference space and a moving sensor,

FIG. 3 schematically shows components required for determination in the case of an object fixedly arranged in the reference space and a moving sensor,

FIG. 4 shows in an exemplary manner a measured and a real aperture as it can be determined according to the present method, and

FIG. 5 shows a measuring situation according to the prior art with an object fixedly arranged in space and a sensor path along which measuring or sensor points of one or more wave-based sensors are arranged in a distributed manner.

### DETAILED DESCRIPTION

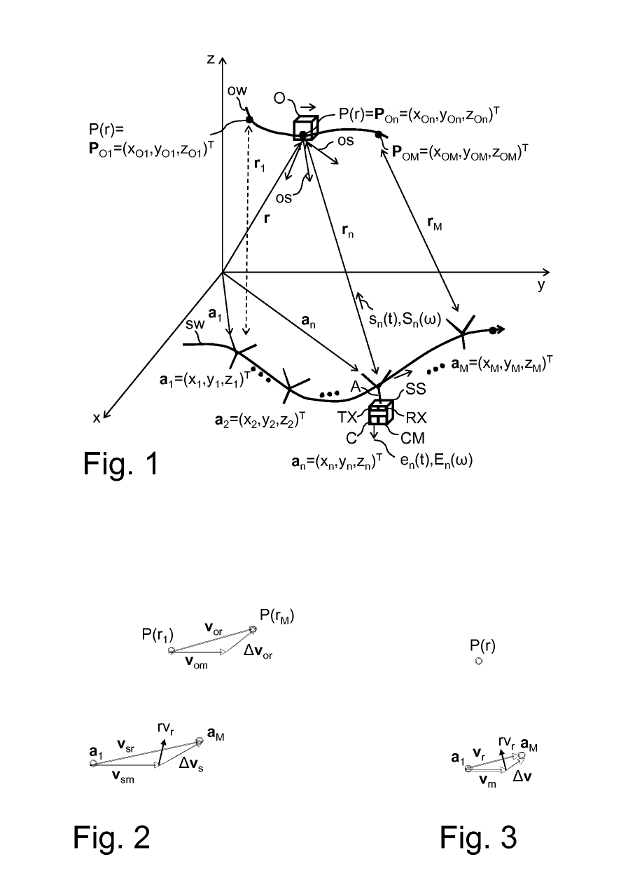

FIG. 1, in a manner complementary to FIG. 5, shows additional components and method quantities resulting from a movement of the object O, which moves at the same time as a movement of the sensor SS, different from the latter in the reference space, here in the Cartesian coordinate system x, y, z. With respect to the components and quantities shown in FIG. 1, additional reference is made to the exhaustive description with reference to FIG. 5 and the derivation of the broadband holographic reconstruction formula.

As can be seen from FIG. 1, the object O with the scatter point P or with a transponder moves along an object path ow. The scatter point P or the transponder assumes various object positions P(r)=(P_{O1}=(x_{O1}, y_{O1}, z_{O1})), . . . , (P_{On}=(x_{On}, y_{On}, z_{On})), . . . , (P_{OM}=(x_{OM}, y_{OM}, z_{OM})) over time t.

The direct measuring paths r₁, . . . , rₙ, . . . , r_{M} between the object positions P(r(t)) and the measured apparent sensor positions a₁=(x₁, y₁, z₁)^{T}, . . . , aₙ=(xₙ, yₙ, zₙ)^{T}, . . . , a_{M}=(x_{M}, y_{M}, z_{M})^{T} thus change within the reference space, i.e., e.g., the Cartesian coordinate system x, y, z, in particular, when the sensor SS is simultaneously moved over time t.

A memory CM within the sensor SS is for storing data, either measured or processed by the processor or other components, in particular received object signals os, the receiving profiles eₙ(t) or data determined therefrom. Moreover or alternatively, a program for causing the sensor SS, in particular its processor C, to carry out the desired data processing, can be stored in the memory CM.

To enable a determination of the object positions P(r(t)) despite using such a movement model, initially the SA sensing and the movement model, known as such, is extended. The following explanations will be in the form of velocity discussions. A transfer of this concept into other movement quantities, such as acceleration quantities or path quantities, are of course possible in a corresponding manner.

As shown in FIG. 2, the wave-based sensor SS moves along the sensor path sw as a sensor trajectory with a instantaneous sensor velocity vector vₛᵣ. The object SS, or each scatter body on the object SS, moves along the object path ow as an object trajectory at a instantaneous object velocity vector vₒᵣ.

As can be seen in FIG. 3, the sensor or object instantaneous velocity vector vₛᵣ and vₒᵣ respectively, is comprised of a known, for example, measured, sensor or object component vₛₘ and vₒₘ, respectively, and of an unknown sensor or object component Δvₛ and Δvₒ respectively. The unknown sensor or object component Δvₛ and Δvₒ, respectively, is unknown due to measuring errors or due to missing information.

Since only the relative movements are relevant in SA methods, the movement vectors of sensor SS and object O can be combined to a common relative movement vector by way of vector subtraction. The instantaneous relative velocity vᵣ is composed in turn of a known relative component vₘ and an unknown relative component Δv. The unknown relative component Δv is the interference quantity that would lead to a failure in the image determination without the preferred approach.

In the reconstruction of an image point, e.g., on the basis of the above mentioned broadband holographic reconstruction formula, if the calculation of the aperture support points remained unchanged, i.e., measured apparent sensor positions aₙ(t) where assumed, they would be predetermined by the known velocity vector vₘ and the measuring time, or the then current time t. These aperture support points, however, deviate from the actual aperture support points, since the unknown relative component Δv of the velocity vector remains unconsidered since the unknown relative component Δv is initially not known. In addition to the deviation due to the aperture support points, according to the method, an unknown relative velocity vector between a moved object O with various object positions P(r) and the aperture support points can be determined, even though coherence is lost due to the various object positions P(r).

According to the reconstruction formula with respect to the broadband holographic image, a number M of complex function values eₙ(t=τₙ) of the echo signals eₙ(t) is summed up, which are extracted from the number M of the echo signals eₙ(t) at each respective direct path signal delay τₙ. This simple summing-up is no longer reliable, or leads to useless results, when an unknown velocity vector Δv is present.

Unlike the above, it is suggested to evaluate this number M of complex function values eₙ(t=τₙ) of the number M of echo signals eₙ(t) in a different manner, to arrive at valid results based on the current relative velocity vᵣ despite the unknown velocity vector as the unknown relative component Δv. For further explanation, the number M of the complex amplitude values of the number M of the function values eₙ(t=τₙ) is first combined to a signal eᵣ(n). For the signal, the following applies:

eᵣ(1)=e₁(t=τ₁), eᵣ(2)=e₂(t=τ₂), . . . , eᵣ(M)=e_{M}(t=τ_{M}).

This signal definition simplifies the above mentioned generally known broadband holographic construction prescription to

$$b ( x , y , z ) = \vert {\sum }_{n = 1}^{M} {e}_{r} ( n ) \vert .$$

The signal eᵣ(n) has generally complex values and can be expressed as follows, separated into the amount and the phase.

eᵣ(n)=|eᵣ(n)|·e^{j·φ}^{ᵣ}⁽ⁿ⁾.

The phase φᵣ(n) will be referred to as the residual phase or the residual phase characteristic.

As can be seen from the preceding explanations, the signal eᵣ(n) and thus also the residual phase φᵣ(n) generally have a different characteristic for each image point b(x, y, z). Hypothetically, a point scatterer is assumed at predetermined coordinates of the coordinate system (x, y, z). If these assumed coordinates correspond to an actual position of the point scatterer or object O with the position P(r)=P_{O1}=(x_{O1}, y_{O1}, z_{O1})^{T}, and, among other things, an assumed geometry, which determines the signal delays, also ideally corresponds to reality, the residual phase φᵣ(n) is a constant. The complex pointers of the signal eᵣ(n) would thus be constructively superimposed as they are summed in this case. The image point b(x, y, z) would then have a high amplitude. In case all quantities determining the signal delay were assumed as being ideally correct, the residual phase φᵣ(n) for all of the number M of the points would even be zero in an identical manner. Each deviation between the assumptions and the actual measuring situation leads to a variation of the residual phase characteristic φᵣ(n).

As has already been indicated with reference to FIGS. 2 and 3, a curvilinear movement trajectory for the number M of the aperture points, i.e., the assumed sensor positions aₙ=(xₙ, yₙ, zₙ)^{T} and the object positions P(r)=Pₒₙ, could be approximated by a linear movement vector if only geometric errors are caused by the linear approximation, whose dimensions are small compared to the wavelength of the measuring signal. Even if this were not the case, at least the unknown velocity vector in the form of the unknown relative component Δv of the velocity vector can often be approximated with sufficient precision as a linear movement vector, as long as only geometric errors are caused by the linear approximation of the unknown velocity vector, whose dimensions are small in comparison to the wavelength of the measuring signal. The unknown velocity vector, or the unknown relative portion Δv can always be separated into two components, one of which faces in the direction of the wave propagation, i.e., in the direction of the direct path rₙ, and the other is vertical thereto.

The component facing in the direction of the direct path rₙ will be referred to as the radial relative velocity rvᵣ, in the following. While assuming a constant linear movement vector, this radial relative velocity rvᵣ has the effect that the residual phase φᵣ(n) of the signal eᵣ(n) linearly varies from point to point. If it is now assumed that the number M of the measurements were carried out at constant time intervals, it becomes apparent that the signal eᵣ(n) describes a sinusoidal oscillation. If the radial relative velocity rvᵣ is equal to zero, the frequency of this oscillation is equal to zero. In this special case, the original form of the SA algorithms and thus also the above mentioned broadband holographic reconstruction formula is applicable.

If the radial relative velocity rvᵣ is unequal to zero, the frequency of the oscillation is also unequal to zero and proportional to the radial relative velocity rvᵣ. Advantageously it is thus suggested according to the method not simply to sum up the number M of the sensor positions or scanning positions of the signal eᵣ(n) in the usual manner, but to calculate their Fourier transformation.

Preferably, a so-called fast Fourier transformation (FFT) is used for this purpose. In a first step the maximum of the amount of the resulting Fourier spectrum is determined. The maximum of the amount of the Fourier spectrum, in a similar manner to the usual broadband holographic reconstruction formula, supplies a probability value. The probability value indicates whether or not a point scatterer or the object O, is present at the position of the space coordinate r. The thus novel image reconstruction formula for the image point is therefore

b(x,y,z)=max {|FFT{eᵣ(n)}|}

and represents an extended broadband holographic reconstruction formula. As an alternative to the determination of the maximum, other quantities could also be determined that depend on the power, or the amplitude of the signal. The average value or the power of the amount spectrum, are examples for quantities that would also be suitable to form a probability value in the above mentioned sense.

However, from the maximum of the resulting Fourier spectrum FFT{eᵣ(n)}, not only a probability value suitable for imaging, but also the unknown relative portion Δv of the velocity vector vₙ can be derived. The position of the maximum within the spectrum additionally supplies the frequency of the oscillation and thus directly a scalar measuring value for the unknown radial relative velocity rvᵣ between the sensor SS and the object point P(r). Consequently, according to the suggested evaluation principle, a radial relative velocity rvᵣ can now be allocated to each image point b(x, y, z).

By way of the method shown, an image point determination is enabled, in particular also with a moving object and simultaneously moving sensor positions, and a correction of an erroneously described aperture. Moving objects O can be imaged in an error-free manner, even if their movements are not a priori known, and errors in the assumed movement velocity of the wave-based sensor SS can even be tolerated.

Now, it is not absolutely necessary for the signal eᵣ(n) to have a linear residual phase characteristic φᵣ (n) and thus to describe a sinusoidal oscillation. For the preferred method it is sufficient if the residual phase characteristic corn) follows any determinable determinism and determines the parameters of this determinism, and are then processed in such a manner that they provide a probability value that indicates whether or not a wave field emanates from the space coordinate r=(x, y, z)^{T}, or which indicates whether the space coordinate r=(x, y, z)^{T} can be used to determine the relative movement between the object and the receiver.

In the case where this signal eᵣ(n) describes a sinusoidal oscillation, the parameters, or function values, of the determinism are, on the one hand the amplitude of the sinusoidal function supplying a probability value that indicates whether or not a wave field emanates from the space position at the space coordinate r=(x, y, z)^{T}, and on the other hand the frequency of the sinusoidal function that is used to determine the relative movement between the object O and the receiver RX of the sensor SS.

To determine the unknown relative movement, in particular the unknown relative velocity rvᵣ between the object O and the receiver RX, or the sensor SS, it is sufficient to form a phase difference Δφ of at least two of the number M of the residual phase values, i.e.,

Δφ=φᵣ(k)−φᵣ(l)

wherein k=1 . . . M; l=1 . . . M ; k≠l. This phase difference Δφ is a direct measure of the deviation between, on the one hand the real geometry, and on the other hand, the geometry assumed at the extraction of function values of the various function values eₙ(t=τₙ) of the echo signals eₙ(t).

The phase difference Δφ also provides the radial distance directly traversed between the measurement of the at least two echo signals eₙ, that the image point b(x, y, z) reconstructed for the object O and the sensor SS have traversed during the number M of the measurements relative to each other, in addition to the assumed movement. The distance traversed is proportional to Δφ, multiplied by the wavelength of the transmitting signal.

In the following, a case frequently found in practice is described. Synthetic apertures are often created by the movement of vehicles or by other technical installations, such as robot arms, stepping motors or linear drives. Sensors SS for velocity or positional detection are often subject to errors in such vehicles or machines, that integratively accumulate during data processing, i.e., become ever larger over time. Depending on the sensor SS used, these error magnitudes often linearly, quadratically or cubically increase over time. A synthetic aperture having the number M of the spatial support points, or the apparently measured, or assumed sensor positions aₙ, is now assumed. Actual, i.e., real, aperture or sensor positions aₙ_{_{—}}ᵣₑₐₗ, which define an aperture, however, deviate by an unknown offset B(n) from the apparently measured sensor positions aₙ due to the above mentioned measuring errors. The real aperture, or the real sensor position aₙ_{_{—}}ᵣₑₐₗ, with which the measurement was carried out, can thus be defined as:

aₙ_{_{—}}ᵣₑₐₗ=aₙ+B(n) (1)

Furthermore, it is assumed that the measurements are carried out at apparent sensor positions aₙ at a constant time interval, namely at a scanning time Tₐ. The offset B(n) can then be described as a function of the index n, for example by way of the following movement equation:

$$B ( n ) = {x}_{0} + {v}_{0} \cdot n + \frac{1}{2} {a}_{0} \cdot {n}^{2} + \frac{1}{3} {r}_{0} \cdot {n}^{3} + … . \qquad ( 2 )$$

Herein, for example, x₀ as the parameter characterizing the function characteristic, describes an offset for the first aperture point, or for the first assumed sensor position, a₁, v₀ is a drift velocity, a₀ is a drift acceleration, and r₀ is a drift jerk, i.e., an acceleration change of the system. Since the first aperture point, i.e., the first assumed sensor position a₁, is freely chosen in space, at least the assumption

xₒ=0 (3)

can be made.

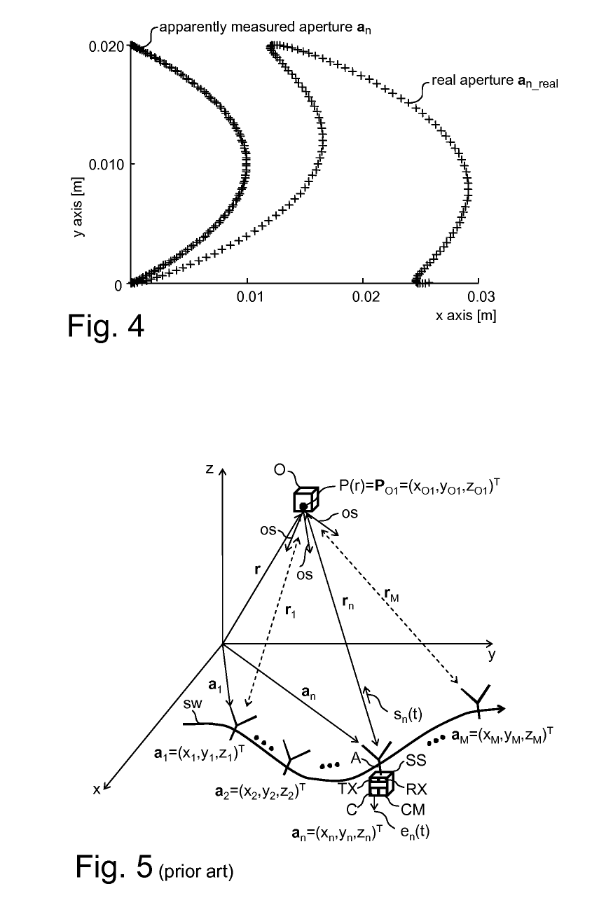

In FIG. 4, an exemplary measure and real aperture is shown for the drift acceleration a₀=0 and the drift jerk r₀=0. Herein, a linear drift can clearly be identified. The drift behavior can also be modeled in any non-linear manner by way of the drift acceleration a₀, the drift jerk r₀ etc.

As has already been shown, for the case where the drift acceleration a₀ and the drift jerk r₀ and all higher non-linear drift components are equal to zero, i.e., if there is only a linear drift component, namely the velocity v₀, the expanded broadband holographic reconstruction formula

b(x,y,z)=max {|FFT{eᵣ(n)}|}

can be used to reconstruct a sharp image from the image points b(x, y, z) in spite of the drift, and the spatial velocity v₀ can also be estimated.

The relationship between the drift and the acceleration component is now determined as a determinism. This determinism can be taken into consideration in an altered reconstruction formula according to the above shown basic principle. This can be implemented as follows:

As already described above, under the assumption of a constant linear movement vector, it follows that the residual phase φᵣ(n) does not linearly vary from point to point over time t, or the index n. In a uniformly accelerated movement, the residual phase φᵣ(n) varies from point to point over time t not in a linear, but in a squared manner. The derivation of the residual phase φᵣ (n) with respect to time, i.e., the difference of the residual phase difference from point pair to point pair, varies linearly in this case.

A possible and sensible processing of the signal eᵣ (n) in this case can be as follows. First, the signal eᵣ (n), as already shown above, is separated into amount and phase:

eᵣ(n)=|eᵣ(n)|·e^{j·φ}^{ᵣ}⁽ⁿ⁾.

Based on the number M of scanning points of signal eᵣ (n), a derived signal is created with a number reduced by one, M−1, of new scanning points as follows:

$$\vert {e}_{r}^{′} ( n ) \vert = \frac{1}{2} ( \vert {e}_{r} ( n ) \vert + \vert {e}_{r} ( n ) \vert )$$

$$arg \{ {e}_{r}^{′} ( n ) \} = arg \{ {e}_{r} ( n + 1 ) \} - arg \{ {e}_{r} ( n ) \}$$

with

e′ᵣ(n)=|e′ᵣ(n)|·e^{j·arg{e′}^{ᵣ}^{(n)}}

The derivation of the phase of the discrete signal can also be carried out as shown in the following:

e′ᵣ(n)=eᵣ(n+1)·eᵣ(n)*

Herein, the asterisk “*” indicates the conjugated complex signal. To avoid squaring the amplitudes as caused by this operation, the signal e′ᵣ(n) can also be derived as follows:

|e′ᵣ(n)|=\sqrt{|eᵣ(n+1)·eᵣ(n)*|}

arg{e′ᵣ(n)}=arg{eᵣ(n+1)·eᵣ(n)*}

Irrespective of which of the above mentioned variants of the signal e′ᵣ(n) was determined, the new expanded broadband holographic reconstruction formula, which is also applicable for an accelerated movement, is then as follows

b(x,y,z)=max {|FFT{e′ᵣ(n)}|}.

In this approach, the image point b(x, y, z) is not determined from the distance, but from the velocity and/or the drift acceleration a₀.

It will be understood that this method can also be repeated in a successive manner for higher non-linear movement components, e.g., when a component, such as the drift jerk r₀, is present that is unequal to zero. The residual phase φᵣ(n) must only be derived a corresponding number of times.

When the explanations are more closely examined, a further interesting option can be derived.

When the drift movement is a linear movement, the residual phase φᵣ(n) varies linearly from point to point over time t. The derived residual phase values, i.e., arg{e′ᵣ(n)} are thus constant. Consequently, assuming a purely linear movement drift, again, the classical reconstruction formula can be used, albeit applied to the derived echo signals e′ᵣ(n) instead of the echo signals eᵣ(n). A suitable image reconstruction prescription is therefore:

$$b ( x , y , z ) = \vert {\sum }_{n = 1}^{M - 1} {e}_{r}^{′} ( n ) \vert .$$

It will be understood that this method can also be repeated in a successive manner for higher non-linear movement components, e.g., when a component, such as the drift jerk r₀, is present that is unequal to zero. The residual characteristic φᵣ(n) is only derived a corresponding number of times, precisely once more than in the reconstruction formula in which the Fourier transformation is used instead of the simple sum.

In both cases it should be noted, however, that the derivation of the residual phase characteristic φᵣ (n) always leads to a loss of information, and that a sharp, easily interpretable image b(x, y, z) then only results, as the case may be, for individual dedicated reflectors, or objects O in the sensing area and, as the case may be, only with non-linear apertures. For wave-based sensors SS measuring passively reflecting targets, as such objects O, e.g., in the case of primary radar devices, this can normally be a problem. For wave-based sensors SS measuring cooperative targets, such as transponders on such objects O, e.g., in the case of secondary radar devices, the problem can be easily avoided by coding the response signal.

This type of reconstruction, in which the derivation of the residual phase characteristic φᵣ(n) is utilized, can be understood as a special case of the concept shown here. In the general case shown here, the limitation that the derivation of the phase always leads to a loss of information no longer applies since the derivation of the phase can be omitted due to the use of the FFT, or all subsequently suggested methods.

The derivation of the residual phase characteristic φᵣ(n) can also be completely omitted for components of a higher order, e.g., the drift acceleration a₀, the drift jerk r₀, if, instead of the Fourier transformation, a transformation is used that is not based on a sinusoidal function.

In this case, a so-called wavelet transformation and other time-frequency transformations are suitable, in particular, which do not necessarily have to be integral transformations. A suitable mother wavelet can be derived for the wavelet transformation directly from the complex movement equation. For a linear drift, the mother wavelet is a sinusoidal oscillation. For a drift with an acceleration component, the mother wavelet is a so-called chirp that is also referred to as a linear frequency modulated signal. For a drift with a shock component, the mother wavelet is a square frequency modulated signal, and so on. By using a suitable transformation, mathematically known as such, the radial components of the drift velocity v₀ of the offset, the drift acceleration a₀, the drift jerk r₀, etc., can be estimated.

It is, of course, also possible to determine suitable mother wavelets for signals sensed in a manner that is not equidistant in time.

It should be generally noted at this stage, that the components may not only be estimated by way of suitable transformations, but alternatively also by way of model-based approaches, mathematically known as such. The transfer of this approach to non-sinusoidal signals is mathematically known as such. The transfer of this approach to signals sensed in a non-equidistant manner in time, is mathematically known as such.

All explanations given so far can also be transferred to systems in which the wave-based sensor SS measures a cooperative target, e.g., a coherently reflecting backscatter transponder on or as the object O.

If applied to cooperative targets, there is also the possibility to additionally determine the velocity measurement already after the first measurement at the first aperture point, or at the first sensor position aₙ by way of evaluating the Doppler shift. In this way, the previously obtained quantities, such as the drift velocity v₀, or the drift acceleration a₀ and the drift jerk r₀, can be obtained more precisely, or according to technically more simple reconstruction prescriptions. For example, the drift acceleration a₀ can be obtained from the FFT of the drift velocities v₀, and thus as a linear relationship. This is theoretically also possible for non-cooperative targets.

By a small modification, all explanations given so far can also be transferred to arrangements in which a signal source emits a signal that is not in a phase-coherent relationship to the receiver. For example, the active transmitter TX, which emits the transmitting signal s(t), can be on the object O itself, so that the transmitting signal itself is emitted from the object rather than the actively or passively reflected object signal. Optionally, a signal emitted by the sensor can also be received, processed and sent back by the transponder at the object, and can be the source of the object's signal transmitted to the sensor SS. In these cases, the signal emitted by an object O, or by a transponder, is sensed by at least two receivers arranged at a known distance with respect to each other, and the phase difference between these two signals sensed by the receivers is used in the further evaluation. To determine the phase difference Δφ, for example, the first of the sensor signals is then multiplied with the conjugated complex of the second of the sensor signals. Secondary radar systems, known as such, can be used, in particular, in this context.

According to a first embodiment, an implementation can be applied, purely for example, to an ambient sensor and an odometer for a fork lift truck, to automated guided vehicles (AGV), to mobile robots or other vehicles, driving in an industrial facility or in an industrial environment, or even on a road, or to robots used in the household for vacuum cleaning etc.

The sensor SS is arranged together with an omnidirectional antenna A, or an antenna number N of omnidirectional antennas A, wherein the antenna number N≧1, on the exemplary vehicle. The vehicle drives, together with the antenna A, or the N antennas, and the number M of measurements is carried out at the measured apparent sensor positions aₙ. Based on this number M of measurements, an image of image points b(x, y, z) of the environment is calculated with the aid of the above described approach. Instead of the antenna number N of the antennas A, for example, a mechanically precisely moveable antenna mounted for example, on a swing plate or on a rotating platform, can be used to sequentially generate the antenna number N of the measured apparent or assumed antenna or sensor positions aₙ.

In the calculation of the image or the image points b(x, y, z), or in the determination of the assumed aperture or sensor positions aₙ, a known portion of the vehicle velocity of the vehicle, determined, for example, by a wheel speed sensor and a steering angle, or by acceleration sensors, can also be used. The assumed synthetic aperture can also be defined, however, solely by the geometric position of the antenna number N of the antennas A, or sensor positions aₙ.

The image alone thus established from image points b(x, y, z) of the environment can be very helpful for navigating a vehicle. It must be pointed out, that a sharp reconstructed image can be created with the method used and thus obstacles and a driving track, for example, can be detected, even when the vehicle's own velocity and thus the aperture positions, i.e., according to the present method, the measured apparent sensor positions aₙ, are not precisely known a priori.

In the next step, if needed, the radial relative velocity rvᵣ with respect to the vehicle can be determined for all highly reflective surfaces O with a known own velocity, i.e., preferably for stationary objects, such as walls, machines, frames, trees, crash barriers in the image of the environment of the vehicle on the basis of the above described method. Based on several differently oriented radial relative velocities rvᵣ, the current relative velocity vᵣ can then be calculated as the vehicle velocity vector of the vehicle relative to the at least one object. With the above mentioned extended method, a velocity vector of the vehicle or movement components of a higher order can of course also be determined.

As soon as the vehicle velocity is known, the angular positions of the individual backscatter centers can be determined as such object positions P(r) by way of the ratio of their velocity to the predetermined vehicle overall velocity in an approximate manner.

If the vehicle velocity vector is known due to a measurement of a different kind, angular positions of the individual backscatter centers can also be determined as such object positions P(r) by way of the ratio of their velocity to the predetermined vehicle overall velocity.

When the waves or object signals os are received as measuring values in the sensor SS, a uniqueness of the spatial scanning of the reflected waves can be ensured either by way of a sufficiently high measuring rate or anti-aliasing approaches.

To determine or estimate the movement of the vehicle and differentiate, from the point of view of the vehicle between stationary objects and moving objects O as sources of the object signals os, preferably, a statistic filter is used, such as a Kalman filter or a particle filter.

The movement of a vehicle can be particularly precisely and advantageously determined if the sensor SS, with an antenna number N of antennas A on the vehicle, measures cooperative targets such as transponders as the object(s) O. A single transponder at a known position, i.e., with a known space coordinate r, can be sufficient to determine the space position, the orientation and the velocity of the vehicle according to the above described method with high precision, even if the vehicle's own velocity is not exactly known. According to the present method, not only the determination of an image of an object or of its position from the point of view of a moved sensor SS is thus possible. Rather, if the object position P(r) is known or constant, or the object movement is known or constant, a position or movement of the device carrying the sensor SS, unknown as such, can also be determined or at least estimated.

According to a second exemplary embodiment, the method can also be used for locating a transponder relative to a mobile, e.g., hand-held, reader as or with the sensor SS, in an advantageous manner. A mobile transponder reader can thus be additionally equipped with acceleration sensors, for example. The number M of the assumed aperture support points, or sensor positions aₙ can thus be determined, for example, by way of twofold integration. Due to the usual errors in the derivation of position values of data from acceleration sensors, the position data will be imprecise and will usually not be suitable for synthetic aperture methods. If the above described approach is used, these errors can be tolerated, however, since the errors are usually subject to a determinism that is caused by the multiple integration and the sensor properties.

The procedure of a measurement can be as follows, for example: a user waves a reader with the antennas number N of antennas A with N≧1 along any possible sensor path sw, for example in a reciprocating manner to the left and right and up and down and to the front and back, or he moves the reader in a circular path in space and thus creates a synthetic aperture, or the number M of assumed sensor positions aₙ as aperture support points. The sensor positions aₙ are estimated in the device by way of the acceleration sensors. With the aid of the above-described method, the location of the transponder as or on the object O is then determined relative to the described synthetic aperture. The indication of the location of the transponder as or on the object O may never be absolutely precise, but it gives the user a very good indication for finding the transponder or the object O.

The above described method is also very advantageous for simultaneously reading several transponders. By the local resolution of the transponders in the image formed of the image points b(x, y, z), on the one hand, the position of the transponders or the objects O with respect to each other and thus their arrangement in space can be determined in front of the reader as the sensor SS, and on the other hand, there are extremely powerful possibilities for the so-called space-division multiplexing method. This method for locating transponders and for space-division multiplexing can be particularly advantageously used with so-called backscatter transponders, as they are known as such in the field of radio frequency identification (RFID).

The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

### LIST OF REFERENCE NUMERALS

A Antenna
a₀ drift acceleration
aₙ=(xₙ, yₙ, zₙ)^{T} measured apparent or assumed nth sensor position
aₙ_{_{—}}ᵣₑₐₗ real sensor position
b(x,y,z) image point
B(n) unknown offset between actual and apparently measured sensor positions aₙ
c propagation velocity of a wave
C processor
CM memory
eₙ(t) echo signal
eᵣ(n) signal from the number M of positions eₙ(t=τₙ) function values for τₙ with 1<n<M of the number M of the measured echo signals
Eₙ(ω) echo spectrum
Fₙ(aₙ, r, ω) ideal function Fₙ(aₙ, r, ω)
M number of echo signals and sensor positions
n element of the sensor positions 1, 2, . . . n, . . . M
n(t) additive white Gaussian noise
N antenna number
N(ω) noise spectrum
O object
os object signal
ow object path
p transmission paths
P scatter point on object
P(r) object position P(r)=P_{O1}=(x_{O1}, y_{O1}, z_{O1})^{T}
P_{TP1}=(x_{TP1}, y_{TP1}, z_{TP1})^{T} ideal reflector position
r space coordinate of object O
r₀ drift jerk
rₙ direct path
rvᵣ radial relative velocity
RX receiver
SS sensor
sₙ(t) transmitting signal
S(ω) transmitting spectrum
sw sensor path
t time
Tₐ scan time Tₐ
TX transmitter
v₀ drift velocity of the offset
vᵣ current relative velocity
vₘ known relative portion of vᵣ
Δv unknown relative portion of vᵣ
vₛᵣ, vₒᵣ sensor or object current velocity
vₛₘ, vₒₘ known sensor or object portion of vₛᵣ, vₒᵣ
Δvₛ, Δvₒ unknown sensor or object portion of vₛᵣ, vₒᵣ
x, y, z Cartesian coordinate system
X₀ offset for the first sensor position a₀
αₙ direct path attenuation
αₚ attenuation for each of the transmission paths beyond αₙ
φ phase of a phase characteristic of the echo signals eₙ(t=τₙ)
φᵣ(n) residual phase, residual phase characteristic, as phase of signal eᵣ(n)
Δφ phase difference
τₙ direct path signal delay
τₚ possible delay extensions
ω circular frequency

1. An imaging method for imaging or locating an object with a wave-based sensor by way of a synthetic aperture, comprising:
receiving an object signal that emanates from an object by at least one sensor at least one sensor position, and the sensor(s) and the object assume a number of at least two spatial positions relative to each other and thus form the synthetic aperture, wherein from at least one object position, a wave field emanates from the object as the object signal, wherein the object signal is produced by either irradiating the object with at least one wave source and, in response, the object reflecting or scattering said wave field, or by the object independently emitting a waveform;
sensing an echo signal by the sensor at each of said sensor positions,
forming a number greater than one of several of the echo signals of the echo signals, wherein at least one of the amplitude and the phase characteristic is a function of a signal delay or a signal delay difference or a function of a distance or a distance difference between the object and at least one of the sensors;
extracting, of this number greater than one of the echo signals, at least one function value per each echo signal, wherein the extracted function values are allocated to an assumed space coordinate of the object;
wherein the number of the extracted function values of the echo signals at their assumed sensor positions have a determinable, deterministic and non-constant residual phase characteristic that is due to at least one of a deviation of real sensor positions from assumed or measured sensor positions and a movement of the object;
the method further comprising:
analyzing or compensating said residual phase characteristic; and
determining or estimating, from the result of the analysis or the compensation, at least one image point of the object or the object position of the object or the relative movement of the object.

2. The method according to claim 1, wherein the determinism of the residual phase characteristic resides in that it linearly varies over time or the index, or in that the extracted function values describe a sinusoidal function and in that at least one of an amplitude, a frequency, and the phase of the sinusoidal function is determined by way of a frequency analysis method.

3. The method according to claim 2, further comprising determining a probability value from the amplitude of the sinusoidal function, which indicates whether or not a wave field emanates from the space coordinate of the object.

4. The method according to claim 2, further comprising determining the relative movement between the object and the at least one sensor from the frequency of the sinusoidal function.

5. The method according to claim 1, further comprising:
forming a phase difference of at least two of the extracted function values; and
determining, using this phase difference, the relative movement between the object and the at least one sensor.

6. The method according to claim 1, further comprising applying a Fourier transformation in a context of the analysis of the extracted function values or of their phase characteristics.

7. The method according to claim 6, wherein, for reconstructing or for estimating at least one of the image points and the spatial drift velocity of an offset between the object and the at least one sensor, the Fourier transformation is applied to at least a part of measuring values of at least two different d echo signals, and a maximum thereof is determined, and this is done, according to:
b(x,y,z)=max{|FFT{eₙ(t=τₙ)}|}
wherein
b(x,y,z) represents the image points; and
eₙ(t=τₙ) represents the function value that is extracted per each echo signal eₙ(t).

8. The method according to claim 1, further comprising:
differentiating the residual phase characteristic of the number of extracted function values;
forming new function values of the extracted function values; and
determining such image points or an image or the object position or the relative movement of the object from the newly formed function values.

9. The method according to claim 8, further comprising repeating the differentiation of the residual phase characteristic until a linear or constant phase characteristic establishes itself in the newly formed function values.

10. The method according to claim 1, wherein the determinism of the phase characteristic is in that
the phase characteristic of the echo signals has a phase, wherein she phase varies in correspondence to a square or cubic function characteristic over time, or wherein the extracted function values describe a linear or square frequency-modulated function, and
with a mathematical analysis method, at least one parameter characterizing the function characteristic, in particular a linear or cubic characteristic, is determined.

11. The method according to claim 1, wherein the measurements at the sensor positions are carried out at constant time intervals during a scanning time.

12. The method according to claim 1, wherein the real sensor position is determined from a sum of an apparently measured sensor position and an offset, wherein the offset is described as a function of an apparently measured n-th sensor position by the parameter characterizing the function characteristic, according to
$$B ( n ) = {x}_{0} + {v}_{0} \cdot n + \frac{1}{2} {a}_{0} \cdot {n}^{2} + \frac{1}{3} {r}_{0} \cdot {n}^{3} + … .$$
wherein:
B(n) is the offset;
x₀ is an offset for the first aperture point, or the first sensor position a₁,
v₀ is a drift velocity,
a₀ is a drift acceleration, and
r₀ is a drift jerk.

13. The method according to claim 1, wherein the analyzed echo signals are sensed by both at least two different apparently measured sensor positions and at least two different object positions.

14. The method according to claim 1 for determining a relative velocity between the sensor and the object as the relative movement or a movement component thereof.

15. An apparatus with a wave-based sensor for sensing a sequence of echo signals of an object and with at least one of a logic element and a processor accessing at least one program, wherein the at least one of the logic element and the processor are configured for carrying out a method according to claim 1.

16. An apparatus according to claim 15, comprising a memory or an interface to a memory, wherein the program is stored in the memory.
